(19) United States
(12) Patent Application Publication
(10) Pub. No.: US 2005/0125286 A1
(43) Pub. Date: Jun. 9, 2005

(54) Voice mail advertising system

(75) Inventors: Jason M. Crippen, Knoxville, TN (US); Mark K. Rogers, Kingston, TN (US)

Correspondence Address: PITTS AND BRITTIAN P C, P O BOX 51295, KNOXVILLE, TN, 37950-1295, US

(73) Assignee: Jason M. Crippen, Knoxville, TN (US)

(21) Appl. No.: 10/726,406

(22) Filed: Dec. 3, 2003

(51) Int. Cl. G06F 17/60

(52) U.S. Cl. 705/14

(57) ABSTRACT

An apparatus for a voice mail advertising system. Incoming telephone calls are routed to a user. If the user does not answer the call, the call is routed to a voice mail server, which communicates with an advertising server. The servers execute software for determining if the user has subscribed to voice mail advertising, selecting an advertisement for playback, playing the advertisement, recording an incoming message, if any, and billing the advertiser if the advertisement was played in its entirety without early termination by the caller.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a voice mail advertising system that produces an audio advertisement upon access of a phone voice mail system by a caller. The number of advertisements made to callers is counted and selected credit is given to the owner of the voice mail system for payment of the cellular phone bill. Advertisers provide credit in return for being allowed to use the voice mail as an advertising medium.

2. Description of the Related Art

Telephone answering systems are known. These systems either take the form of a stand-alone device attached to a telephone line or are services offered by a service provider. The telephone answering services are either automated systems or have humans answer the phone.

The following are examples of telephone voice mail systems. U.S. Pat. No. 5,937,047, titled “Remote Voice Mail Messaging and Management System,” issued to Stabler on Aug. 10, 1999, discloses a voice messaging and management system. U.S. Pat. No. 6,350,066, titled “Systems and Methods for Storing, Delivering, and Managing Messages,” issued to Bobo, II, on Feb. 26, 2002, discloses a voice mail system connected to the Internet. U.S. Pat. No. 6,564,321, titled “Systems and Methods for Storing, Delivering, and Managing Messages,” issued to Bobo, II on May 13, 2003, discloses a system for routing messages to intended recipients.

Other telephone systems have been developed for managing data and messages. For example, U.S. Pat. No. 5,301,223, titled “Cellular Telephone System with Remote Programming, Voice Responsive Registration and Real Time Billing,” issued to Amadon, et al. on Apr. 5, 1994, discloses a cellular telephone rental system.

U.S. Pat. No. 6,590,970, titled “Intelligent-Networked Telephone System Having Advertisement with Bonus Free Phone Call Service,” issue to Cai, et al., on Jul. 8, 2003, discloses a system in which a customer is permitted to make a free telephone call after listening to an advertisement. The bonus call is limited to a predefined duration monitored by a timer reset at the beginning of the bonus call. The system includes a switch that routes the free calls and an intelligent peripheral that stores a pre-recorded menu and advertisements. The intelligent peripheral allows a customer to select a product or service advertisement for playback.

U.S. Pat. No. 6,606,596. titled “System and Method for the Creation and Automatic Deployment of Personalized, Dynamic and Interactive Voice Services, Including Deployment Through Digital Sound Files,” issued to Zirngible, et al., on Aug. 12, 2003, discloses the creation and automatic deployment of personalized, dynamic, and interactive voice services. Zirngible discloses delivery of voice service information through a digital sound file.

### BRIEF SUMMARY OF THE INVENTION

According to one embodiment of the present invention, an apparatus for a voice mail advertising system is provided. Incoming telephone calls are routed to a user. If the user does not answer the call, the call is routed to a voice mail server, which communicates with an advertising server. The servers execute software for determining if the user has subscribed to voice mail advertising, selecting an advertisement for playback, playing the advertisement, recording an incoming message, if any, and billing the advertiser if the advertisement was played in its entirety without early termination by the caller.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of a voice mail advertising system;

FIG. 2 is a block diagram of one embodiment of the steps for processing an incoming call; and

FIG. 3 is a block diagram of one embodiment of the steps for playing an advertisement message.

### DETAILED DESCRIPTION OF THE INVENTION

An apparatus for a voice mail advertising system 10 is disclosed. The voice mail advertising system 10 produces an audio advertisement upon access of a phone voice mail system by a caller. The number of advertisements made to callers is counted and selected credit is given to the owner of the voice mail system for payment of a cellular phone bill. Advertisers provide credit in return for being allowed to use the voice mail as an advertising medium

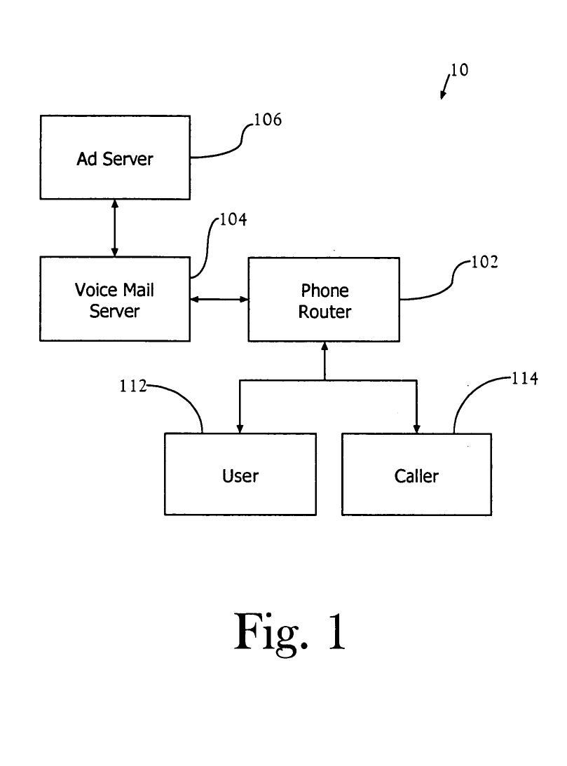

FIG. 1 illustrates one embodiment of the voice mail system 10. A caller 114 dials the number of a cellular phone user 112. The call is routed by the phone router 102 to the user 112. If the user 112 is not available or chooses not to answer the call, the phone router 102 routes the telephone call to a voice mail server 104, which responds to the caller 114. The voice mail server 104 queries the advertisement server 106 for an advertisement that is played as part of the outgoing message to the caller 114.

The caller 114 is any person calling the user 112. The caller 114 originates the call from a POTS, cellular, or other type of telephone. In the illustrated embodiment, the user 112 is a cellular telephone user. In another embodiment, the user 112 is a subscriber to a remote voice mail system that monitors the telephone of the user 112.

The telephone router 102 includes the equipment of the telephone service provider that handles telephone calls, both those of the user 112 and those of callers 114. The telephone service provider is a phone service company providing standard or enhanced services to an individual or company, including voice mail.

The voice mail server 104 provides presentation and retention of voice mail for multiple users 112. In one embodiment, the calls are digitally recorded and stored for presentation to the user 112. The user 112 plays back these messages at a later time. Voice mail servers 104 provide services to callers 114 ranging from simple to complex. For example, a simple service plays a message for the user 112 to callers 114, and records a reply from the caller 114. The reply is played back to the user 112 when the user 112 queries the system. An example of a complex system is one that presents the caller 114 with a menu of options from which the caller 114 chooses one. The options range from leaving a message for the user 112 to sending a text message to the user 112.

The advertisement server 106 interacts with the voice mail server 104 for providing the caller with various advertisements as part of the voice mail system 10. The advertisement server 106 stores the advertisements and billing information relating to the advertisements. In the illustrated embodiment, the voice mail server 104 and the advertisement server 106 are illustrated as individual servers. Those skilled in the art will recognize that the functions performed by each server 104, 106 can be performed by a single server running software that contains the functions described herein for each server 104, 106.

The voice mail server 104 and the advertisement server 106 should be broadly construed to mean a computer, computer platform, an adjunct to a computer or platform, or any component thereof that provides data or information to a client, such as the phone router 102, the user 112, the caller 114, or a computer workstation. The voice mail server 104 and the advertisement server 106 run, or execute, software that allows the servers 104, 106 to properly handle and process client requests, in addition to other processes necessary for the servers 104, 106 to perform their required functions. Of course, a client should be broadly construed to mean the equipment that requests or gets a file or information, and a server is the equipment that provides the file or information.

The voice mail server 104 and the advertisement server 106 should also be broadly construed to mean any computer or component thereof that executes software. In one embodiment the voice mail server 104 and the advertisement server 106 are general purpose computers, in another embodiment, the voice mail server 104 and the advertisement server 106 are specialized devices for implementing the functions described herein. Those skilled in the art will recognize that it is possible to program a general-purpose computer or a specialized device to implement the functions described herein. Those skilled in the art will recognize that the voice mail server 104 and the advertisement server 106 each includes an input component, an output component, a storage component, and a processing component. The input component receives input from external devices, such as the phone router 102 and other servers 104, 106. The output component sends output to external devices, such as the phone router 102 and other servers 104, 106. The storage component stores data, including voice mail messages and advertisements, and program code. In one embodiment, the storage component includes random access memory. In another embodiment, the storage component includes non-volatile memory, such as floppy disks, hard disks, and writeable optical disks. The processing component executes the instructions included in the software and routines.

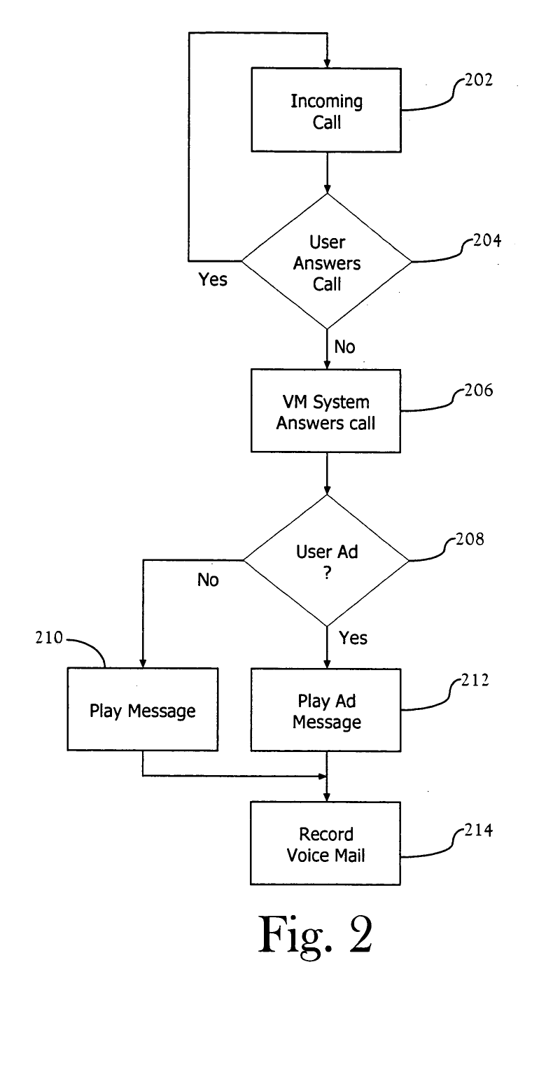

FIG. 2 illustrates one embodiment of the steps for processing an incoming call by the voice mail system 10. Incoming calls 202 are received and routed to the user 112. If the user 112 answers the call 204, the call is terminated and the system 10 returns to waiting for an incoming call 202. If the user 112 does not answer the call 204, the voice mail system answers the call 206. The system 10 checks to see if the user 112 has subscribed to voice nail advertising 208. If the user has not, an outgoing message is played 210 for the caller and the caller's incoming message, if any, is recorded 214. If the user 112 has subscribed to voice mail advertising 208, the system 10 plays the advertisement message 212 and then the caller's message, if any, is recorded 214. In one embodiment, if the user 112 does not answer the call 204, the telephone router 102 routes the unanswered telephone call to the voice mail server 104.

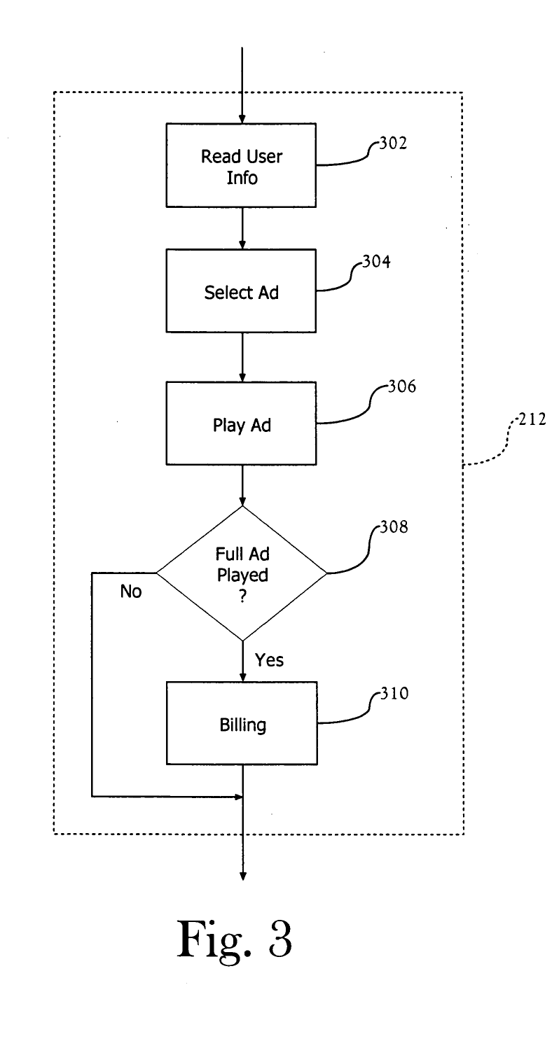

FIG. 3 illustrates one embodiment of the steps for playing an advertisement message 212. The voice mail server 104 runs a routine to read the user data 302. The user data includes information on the advertisements selected by the user 112 for playback. The next step is to select the advertisement to play 304 and then to play that advertisement 306. If the full advertisement is played 308 without the caller 114 terminating the call, the user 112 receives credit for the advertisement and the billing 310 routine is invoked. If the caller 114 terminates the call without the advertisement being played in its entirety, the billing 310 routine is skipped. It is possible that no message will be left by the caller 114 to the user 112, but that will not be used to quantify whether or not the caller 114 has heard the advertisement.

The advertisement server 106 contains digital voice files for the advertisements. The user 112 selects one or more advertisements for playback. The advertisements are short messages that promote a good or service. For example, one advertisement message states, “Remember to use XYZ for your Internet search engine, and leave Jason a message.” In this example, the name of the user 112 is part of the advertising message.

The voice mail advertising system provider recruits advertisers. Each time a voice mail advertisement is heard in its entirety by a caller 114, the advertiser is charged an amount of money, or advertiser fee. In one embodiment, the voice mail advertising system provider retains a percentage of the advertiser fee and the user 112 receives the remainder of the advertiser fee. In one embodiment, the portion retained by the user 112 is applied as a credit to the user's telephone bill. The billing 310 routine tracks the activity of advertisement messages played and the associated charges and fees.

In one embodiment, calls duplicated from the same originating number to the telephone user 112 are not credited for advertising over a specified period. In various embodiments, the specified period is between 24 and 48 hours.

In one embodiment, the advertising server 106 maintains digitally stored messages from the telephone user 112 to be presented to the caller 114. The advertising server 106 maintains a database of tables. In one embodiment, a table contains fields identifying the user 112, the advertisement played 304, 306, the caller 114 who received the advertisement, and the date and time the advertisement was played 306.

Additional information relating to the data structure may be helpful. Such information may include fields for the various tables and the relationship between tables and fields.

In one embodiment, the key identifier is the telephone number of the cell phone user 112, a cellular telephone advertisement identification number is a secondary identifier, and an advertisement order identifier is also a secondary key (if multiple advertisements are setup by the cell phone user). Included in the database are custom tag phrases that the user 112 can incorporate into the advertisements going out to the caller 114, for example, the user's name or company title. The advertisement system tracks the number of times the advertisement has been played to callers 114 and the remaining times available for it to be played. Each interaction within the advertisement system generates an entry into a master log for tracking purposes and verification purposes. Charges and system credits for an advertisement are predetermined before the user 114 selects an advertisement for use. The advertisement system has an interface for entering new advertisements and for making adjustments to advertising fees or credits. The advertising server 106 interacts with the voice mail server 104 with the voice mail server 104 maintaining a key value indicating whether the user 112 participates in the advertising system 10.

In one embodiment, each of the functions identified in FIGS. 2 and 3 are performed by one or more software routines run by the servers 104, 106. In another embodiment, one or more of the functions identified are performed by hardware and the remainder of the functions are performed by one or more software routines run by the servers 104, 106. In still another embodiment, the functions are implemented with hardware, with the servers 104, 106 providing routing and control of the entire integrated system 10.

The servers 104, 106 execute software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, as used herein, a routine refers to code that performs a specified function, whereas software is a more general term that may include more than one routine or perform more than one function.

The voice mail advertising system 10 includes various functions. The function of routing an unanswered telephone call from a caller 114 to a user 112 is implemented by the telephone router 102. The function of playing an advertisement for the caller 114 is implemented, in one embodiment, by the voice mail server 104, the advertising server 106, and the software executed on the servers 104, 106. The function of billing an advertiser for playing an advertisement is implemented by the billing routine 310 executed on one or the other of the servers 104, 106. The function of crediting the user for playing an advertisement is implemented by the billing routine 310 executed on one or the other of the servers 104, 106. The function of receiving a message from a caller is implemented by the voice mail server 104.

From the foregoing description, it will be recognized by those skilled in the art that a voice mail advertising system 10 has been provided. Incoming telephone calls are routed to a user. If the user does not answer the call, the call is routed to a voice mail server, which communicates with an advertising server. The servers execute software for determining if the user has subscribed to voice mail advertising, selecting an advertisement for playback, playing the advertisement, recording an incoming message, if any, and billing the advertiser if the advertisement was played in its entirety with early termination by the caller.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A system for voice mail advertising, said system comprising:
at least one server programmed to execute a process including
selecting an advertisement for playback,
playing said advertisement to a caller;
determining whether said caller terminated playback of said advertisement, and
billing an advertiser if said caller did not terminate playback of said advertisement.

2. The system of claim 1 wherein said process further includes reading a plurality of user information.

3. The system of claim 1 wherein said process further includes a user customizing said advertisement.

4. The system of claim 1 wherein said process step of billing said advertiser includes charging said advertiser an advertiser fee and crediting a user a portion of said advertiser fee.

5. The system of claim 1 further including a telephone router for routing an unanswered telephone call to said at least one server.

6. The system of claim 1 further including a telephone router for routing an unanswered telephone call to said at least one server, said unanswered telephone call being directed originally to a cellular telephone user.

7. A system for voice mail advertising, said system comprising:
a telephone router;
a storage component for advertisements and messages;
an input/output component for communicating with said telephone router; and
a processing component executing a process including
customizing said advertisement by a user,
reading a plurality of user information,
selecting an advertisement for playback,
playing said advertisement to a caller;
determining whether said caller terminated playback of said advertisement, and
billing an advertiser if said caller did not terminate playback including charging said advertiser an advertiser fee and crediting a user a portion of said advertiser fee.

8. A system for voice mail advertising, said system comprising:
a means for routing an unanswered telephone call from a caller to a user;
a means for playing an advertisement for said caller;
a means for billing an advertiser for playing said advertisement;
a means for crediting said user; and
a means for receiving a message from said caller.

9. The system of claim 8 wherein said user is a cellular telephone user.

10. A system for voice mail advertising, said system comprising:
at least one server programmed to execute a process including
customizing said advertisement by a user,
reading a plurality of user information,
selecting an advertisement for playback,
playing said advertisement to a caller;
determining whether said caller terminated playback of said advertisement, and
billing an advertiser if said caller did not terminate playback including charging said advertiser an advertiser fee and crediting a user a portion of said advertiser fee; and
a telephone router for routing an unanswered telephone call to said at least one server, said unanswered telephone call being originally directed to a cellular telephone user.

11. At least one computer programmed to execute a process for voice mail advertising, the process comprising
selecting an advertisement for playback;
playing said advertisement to a caller;
determining whether said caller terminated playback of said advertisement; and
billing an advertiser if said caller did not terminate playback.

12. The process of claim 11 wherein said step of billing said advertiser includes charging said advertiser an advertiser fee and crediting a user a portion of said advertiser fee.

13. The process of claim 11 further including reading a plurality of user information.

14. The process of claim 11 further including customizing said advertisement by a user.

15. A program storage device readable by a machine, tangibly embodying a program of instructions executable by the machine to perform method steps for voice mail advertising, said method comprising:
selecting an advertisement for playback;
playing said advertisement to a caller;
determining whether said caller terminated playback of said advertisement; and
billing an advertiser if said caller did not terminate playback.

16. The process of claim 15 wherein said step of billing said advertiser includes charging said advertiser an advertiser fee and crediting a user a portion of said advertiser fee.

17. The process of claim 15 further including reading a plurality of user information.

18. The process of claim 15 further including customizing said advertisement by a user.

19. Computer readable media tangibly embodying a program of instructions executable by a computer to perform a method of voice mail advertising, said method comprising:
selecting an advertisement for playback;
playing said advertisement to a caller;
determining whether said caller terminated playback of said advertisement; and
billing an advertiser if said caller did not terminate playback.

20. The process of claim 19 wherein said step of billing said advertiser includes charging said advertiser an advertiser fee and crediting a user a portion of said advertiser fee.

21. The process of claim 19 further including reading a plurality of user information.

22. The process of claim 19 further including customizing said advertisement by a user.
